(19) United States
(12) Patent Application Publication
(10) Pub. No.: US 2005/0128878 A1
(43) Pub. Date: Jun. 16, 2005

(54) Transformerless clock radio

(75) Inventor: Wong Shue Kwan, Hong Kong (HK)

Correspondence Address: BROOKS KUSHMAN P.C., 1000 TOWN CENTER, TWENTY-SECOND FLOOR, SOUTHFIELD, MI, 48075, US

(73) Assignee: Centre Way Holdings Ltd., Hong Kong (HK)

(21) Appl. No.: 10/733,882

(22) Filed: Dec. 11, 2003

(51) Int. Cl. G04C 19/00

(52) U.S. Cl. 368/82

(57) ABSTRACT

A timepiece including a liquid crystal display (LCD), a battery powered circuit for driving the LCD and determining a time, and one or more alternating current (AC) powered lights configured as a back light to the LCD. The one or more AC powered lights function when plugged into an AC power source.

### BACKGROUND OF THE INVENTION

1. Field of the Invention

One embodiment of the present invention relates to a transformerless clock radio and, more specifically, to an AC and DC powered clock radio that does not need a transformer or a rectifier circuit.

2. Background Art

Timepieces are daily necessities for most people. Timepieces are generally classified as either analog or digital devices. Conventional analog timepieces are usually equipped with luminous devices so that the displayed time can be clearly seen in a dark environment. Typically, by pressing a button, the user can activate the light that illuminates the dial, allowing the user to clearly see the time as indicated by the arms. However, finding the timepiece and pressing the button in the dark can be a challenge.

Digital timepieces are available that display the time using light-emitting diodes (LEDs). With LED-based timepieces, the displayed time is clearly visible in the dark. However, LED devices consume high levels of energy and need an AC power source. For this reason, it is not practical to use dry batteries with LED-based timepieces and a transformer must be installed. If a power failure occurs, the time will have to be reset when the power is restored. LED timepieces are usually large in size, which makes them difficult to implement in increasingly compact electronic products. Furthermore, graphics displayed by LED displays have a low resolution. For this reason, LED displays are typically used only to display simple numerical or textural data in a monotonous style. Digital timepieces available in the marketplace mainly use liquid crystal display (LCD) technology to display the time. LCD technology consumes less energy than LED technology and is more suited to displaying high resolution graphics. However, LCD devices are not self-luminous. Hence, a light source is needed to display the graphics in a manner that is easily visible.

If a LCD is not equipped with a back light device, the display is not generally visible in the dark, leaving the user to rely on ambient light to see the display on the screen. Typically, back light devices are installed behind the LCD screen to illuminate the LCD. Presently, there are at least three categories of back light sources: electroluminescent lamps (EL), cold cathode fluorescent lamps (CCFL), and LED. These light sources can shed light laterally or vertically. The basic principle of back light technology is to pass light directly through the display screen and on to a viewer to make the LCD graphical content easily visible. However, these back light devices suffer from a relatively complicated structure and are susceptible to higher production costs and require advanced manufacturing technology. These back light devices also require the installation of transformers or rectifier and voltage drop circuits, which decreases efficiency and consumes more energy, since transformer or rectifier and voltage drop circuits are not 100% efficient.

It would be desirable to have a LCD-based timepiece with a back light that does not need a transformer or a voltage drop and rectifier circuit and does not lose track of the time in the event of a power failure. It would further be desirable to have a LCD-based timepiece that has few parts and is economical to manufacture.

### SUMMARY OF THE INVENTION

According to one aspect of the present invention, a timepiece is provided that operates on alternating current (AC) and direct current (DC) power and does not need a transformer or rectifier circuit. The timepiece includes a liquid crystal display (LCD), a battery powered circuit for driving the LCD and determining a time, and one or more AC powered lights configured as a back light to the LCD. The one or more AC powered lights function when plugged into an AC power source. Another aspect of the timepiece may be that it does not include a transformer or a rectifier circuit. The timepiece may be a clock. Specifically, the timepiece may be a digital clock. The one or more AC powered lights may include one or more neon lights that may function only when plugged into the AC power source. The battery power may be supplied by one or more AA batteries. The timepiece may further include an alarm that progressively increases in volume as the alarm sounds and a snooze button that delays the alarm for a period of time. The timepiece may continue to determine the time while the battery is at least partially charged and remains in contact with the battery powered circuit.

In an alternative embodiment of the present invention, a digital alarm clock is provided that includes a LCD, a battery, a battery powered digital clock circuit for driving the LCD and determining a time, and one or more AC powered neon lights configured as a back light to the LCD. The one or more AC powered neon lights function only when plugged into an AC power source and the digital clock circuit functions only when connected to the battery. The digital alarm clock does not include a transformer or a rectifier circuit.

In another embodiment of the present invention, a timepiece is provided that includes a housing, a LCD, an AC powered back light to the LCD, a reflector located between the LCD and the back light, a battery, and a battery powered printed circuit board configured to drive the LCD and determine a time. The timepiece may be a digital alarm clock. The reflector of the timepiece may comprise flame retardant polycarbonate (PC) and the housing may comprise flame retardant acrylonitrile-butadiene-styrene (ABS). The timepiece does not include a transformer or a rectifier circuit. The AC powered back light may include one or more neon lights powered by a conventional 120V 60 Hz or 220V 50 Hz power source, depending on the location of the user. Each neon light may be connected in parallel with all of the one or more neon lights. Additionally, each neon light may be coupled in series with a resistance. In one example, the resistance may be between 68 and 82 kilo-Ohms. The timepiece may further include a plurality of switches connected to the battery powered printed circuit board, which function to set the date, time, and alarm configuration of the timepiece. The timepiece may further include an alarm transducer and one or more capacitors connected to the battery powered printed circuit board.

These and other aspects of the present invention will be better understood in view of the attached drawings and following detailed description of several illustrative embodiments of the present invention.

### BRIEF DESCRIPTION OF THE DRAWINGS

FIG. 1 is a diagram illustrating an example cross section of a timepiece construction in accordance with an embodiment of the present invention;

FIG. 2 is a diagram illustrating an exploded vertical cross section of the AC powered back light assembly that is part of the timepiece shown in FIG. 1;

FIG. 3 is a diagram illustrating a horizontal cross section of the AC powered back light assembly; and

FIG. 4 is a circuit diagram of the timepiece shown in FIG. 1.

### DETAILED DESCRIPTION OF THE PREFERRED EMBODIMENTS

The present invention relates to an illuminating device for Liquid Crystal Display (LCD) timepieces. In one example, the present invention pertains to a neon lamp back light device for LCD timepieces such as alarm clocks and watches.

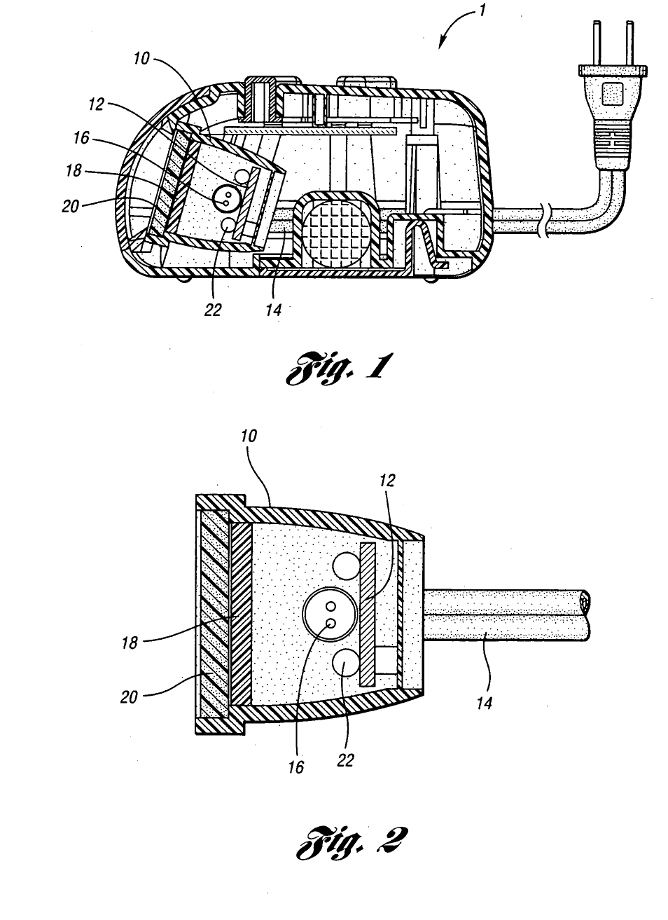

Referring to FIG. 1, a diagram is shown illustrating an example timepiece construction in accordance with an embodiment of the present invention. As shown in FIG. 1, the AC powered back light device of the present invention is applied to a digital alarm clock 1. The AC powered back light is installed behind a LCD screen. The back light assembly of the timepiece 1 generally comprises a housing 10, a printed circuit board (PCB) 12, an electric wire 14, an AC powered light source 16, a lens 18, a LCD 20, and one or more limiting resistors 22. The housing 10 may be made of a plastic material in the shape of a bowl and may be molded into one piece using an injection molding process. The front area of the housing 10 may be larger than the back area. The housing 10 may have a curved side surface, the inside of which can be covered with white paint or a reflective coating to achieve brighter and more evenly distributed light dispersion. The printed circuit board 12 may be installed at the back of the inside of the housing 10 in which there is a hole for the electric wire to pass through for connecting the AC powered light source 16 to an AC power supply. In one example, the AC powered light source 16 may be one or more neon lights. The AC powered light source 16 may connect to an AC power source such as an electric wall socket through the electric wire 14.

In one example, the AC powered light source 16 may comprise five neon glow lamps that emit a glow. The color of the glow may be orange, blue, green, or any other color. The AC powered light source 16 may be installed on the front surface of the printed circuit board 12. In one example, the neon glow lamps 16 may be arranged on the printed circuit board 12 in a single file in an “H” shape and may be electrically connected to the printed circuit board 12. In one example, the one or more limiting resistors 22 may comprise 5 limiting resistors and may also be installed on the front surface of the printed circuit board 12. The quantity and the arrangement of the limiting resistors 22 may be similar to that of the neon glow lamps 16. There may be a groove along the edge at the front opening of the housing 10 to securely position the lens 18. In one example, the lens 18 may be a transparent diffusing plastic sheet. The transparent diffusing plastic sheet 18 may cover the five neon glow lamps 16 to provide more evenly distributed light. The LCD 20 of the alarm clock 1 may be powered by dry batteries.

After the circuit on the printed circuit board 12 is connected, AC power is supplied to the AC powered light source 16 through the electric wire 14 to drive the AC powered light source 16 to glow, emitting light that is directed through the LCD 20. The AC powered light source 16 provides light in the dark, allowing the user to see the time or other graphics shown on the LCD 20.

Referring to FIG. 2, a diagram is shown illustrating a vertical cross-section of the AC powered back light assembly that is part of the timepiece in FIG. 1. In the embodiment of FIG. 2, the housing 10 houses the PCB 12, the connecting end of the electric wire 14, the AC powered light source 16, the lens 18, the LCD 20, and the limiting resistors 22. The AC powered light source 16 and the limiting resistors 22 are mounted on the PCB 12, which is positioned at the back side of the housing 10. The electrical wire 14 enters the housing 10 through a hole in the rear of the housing 10 and connects to the PCB 12. Light emitted from the AC powered light source 16 travels towards the front of the housing 10, through the lens 18, through the LCD 20, and out the front of the housing 10.

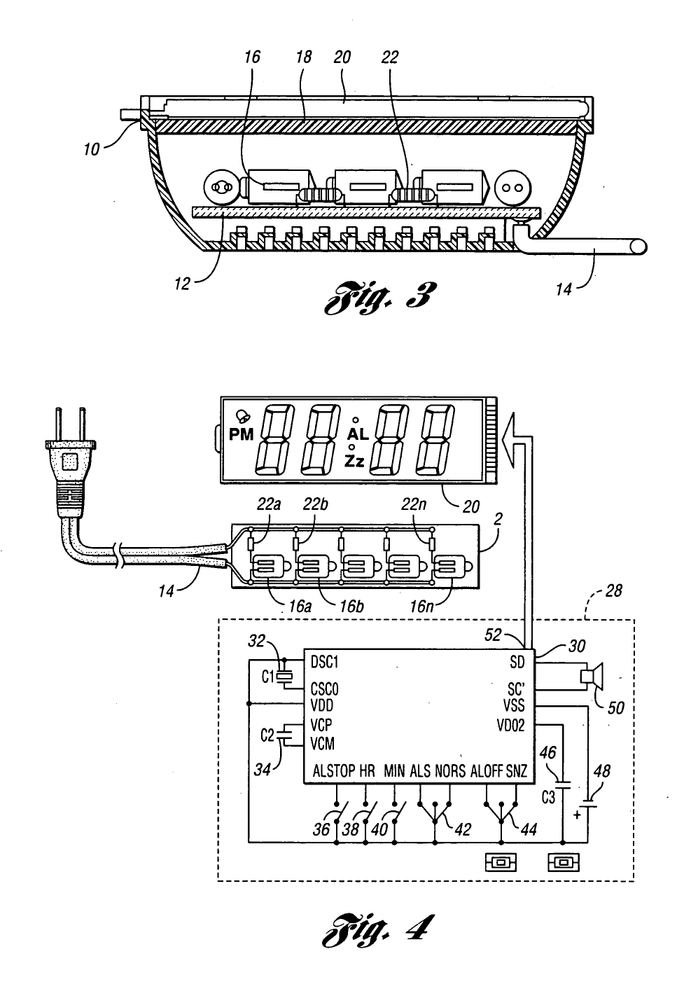

Referring to FIG. 3, a diagram is shown illustrating a horizontal cross-section of the AC powered back light assembly. FIG. 3 more clearly illustrates an example arrangement of the neon lights 16 and the limiting resistors 22 on the PCB 12.

Referring to FIG. 4, a circuit diagram is shown of the timepiece 1. The circuit of the timepiece 1 generally comprises the PCB 12, the LCD 20, and a second PCB 28. The second PCB 28 has a clock circuit 30 mounted on it. The clock circuit 30 has a number of inputs and outputs. The clock circuit 30 may be connected to a capacitor 32, a capacitor 34, a switch 36, a switch 38, a switch 40, a switch 42, a switch 44, a capacitor 46, a DC power source 48, and a transducer 50. The capacitor 32 may be connected between an input OSC1 and an input CSC0. The input OSC1 may also be connected to a positive side of the DC power source 48. The capacitor 34 may be connected between an input VCP and an input VCM. The switch 36 may be connected to an input ALSTOP. The switch 38 may be connected to an input HR. The switch 40 may be connected to an input MIN. The switch 42 may be connected between two inputs ALS and NORS. The switch 44 may be connected between two inputs ALOFF and SNZ. All switches 36 through 44 may also be connected to the positive side of the DC power source 48. The capacitor 46 may be connected between the positive side of the DC power source 48 and an input VD02. The power source 48 may be connected between an input VDD and an input VSS. The transducer 50 may be connected between an output SD and an input SD′. The clock circuit 30 may have an output 52 that is connected to and drives the LCD display 20.

The AC powered light source 16 may comprise a number of lights 16a-n. There may be one limiting resistor for each of the AC powered lights 16a-n, labeled 22a-n. As shown in FIG. 4, the AC powered light source 16 (e.g., the AC powered lights 16a-n) and the wire 14 connected to the AC powered light source 16 may not be electrically connected to the clock circuit 30 or the LCD display 20. The clock circuit 30 and the LCD display 20 may be powered by the DC voltage source 48. In one example, the DC voltage source 48 may be one or more 1.5 volt batteries. The AC powered light source 16 may only be powered by the wire 14 leading to an AC power source. In one example, the AC power source may be a conventional 120 volt 60 Hz supply or a 240 volt 50 Hz supply, depending on the location of the user. However, any AC power source may be used to meet the design criteria of a particular application.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A timepiece comprising:
a liquid crystal display (LCD);
a battery powered circuit for driving the LCD and determining a time; and
one or more alternating current (AC) powered lights configured as a back light to the LCD,
wherein the one or more AC powered lights function when plugged into an AC power source.

2. The timepiece of claim 1 wherein the timepiece does not include a transformer or a rectifier circuit.

3. The timepiece of claim 1 wherein the timepiece is a clock.

4. The timepiece of claim 2 wherein the clock is a digital clock.

5. The timepiece of claim 1 wherein the one or more AC powered lights comprise one or more neon lights.

6. The timepiece of claim 1 wherein the one or more AC powered lights function only when plugged into the AC power source.

7. The timepiece of claim 1 wherein the battery power is supplied by one or more AA batteries.

8. The timepiece of claim 1 further comprising an alarm that progressively increases in volume as the alarm sounds.

9. The timepiece of claim 8 further comprising a snooze button that delays the alarm for a period of time.

10. The timepiece of claim 1 wherein the timepiece continues to determine the time while the battery is at least partially charged and remains in contact with the battery powered circuit.

11. A digital alarm clock comprising:
a liquid crystal display (LCD);
a battery;
a battery powered digital clock circuit for driving the LCD and determining a time; and
one or more alternating current (AC) powered neon lights configured as a back light to the LCD,
wherein the one or more AC powered neon lights function only when plugged into an AC power source and the digital clock circuit functions only when connected to the battery.

12. The digital alarm clock of claim 11 wherein the digital alarm clock does not include a transformer or a rectifier circuit.

13. A timepiece comprising:
a housing;
a liquid crystal display (LCD);
an alternating current (AC) powered back light to the LCD;
a reflector located between the LCD and the back light;
a battery; and
a battery powered printed circuit board configured to drive the LCD and determine a time.

14. The timepiece of claim 13 wherein the timepiece is a digital alarm clock.

15. The timepiece of claim 13 wherein the reflector comprises flame retardant polycarbonate (PC) and the housing comprises flame retardant acrylonitrile-butadiene-styrene (ABS).

16. The timepiece of claim 13 wherein the timepiece does not include a transformer or a rectifier circuit.

17. The timepiece of claim 13 wherein the AC powered back light comprises one or more neon lights powered by a conventional 120V 60 Hz or 220V 50 Hz power source.

18. The timepiece of claim 17 wherein each neon light is connected in parallel with all of the one or more neon lights and each neon light is coupled in series with a resistance between 68 and 82 kilo-Ohms.

19. The timepiece of claim 13 further comprising a plurality of switches connected to the battery powered printed circuit board and functioning to set the date, time, and alarm configuration of the timepiece.

20. The timepiece of claim 19 further comprising an alarm transducer and one or more capacitors connected to the battery powered circuit board.
